(19) United States
(12) Patent Application Publication
(10) Pub. No.: US 2013/0041874 A1
(43) Pub. Date: Feb. 14, 2013

(54) INTERACTIVE DOCUMENTATION SYSTEM FOR DATABASE PARAMETERS

(71) Applicants: Susan M. Dohm, Apex, NC (US); Joann E. Janclk, Victoria, MN (US)

(72) Inventors: Susan M. Dohm, Apex, NC (US); Joann E. Janclk, Victoria, MN (US)

(21) Appl. No.: 13/226,531

(22) Filed: Sep. 7, 2011

Related U.S. Application Data
(60) Provisional application No. 61/522,094, filed on Aug. 10, 2011.

(51) Int. Cl. G06F 17/30

(52) U.S. Cl. 707/705; 707/E17.01; 707/E17.127

(57) ABSTRACT

Help documentation for the application may include a discussion of parameters in the application. Parameters for an application may be displayed through a web-based interface along with information for each of the parameters. Additional information may be obtained regarding the parameters by allowing interactive access with databases supporting the application. For example, when a user clicks a parameter name in the help documentation, a value for the parameter and additional data may be retrieved from the parameter database and displayed to the user in a pop-up window.

### CROSS-REFERENCE TO RELATED APPLICATIONS

This applications claims the priority date of U.S. Provisional Patent Application No. 61/522,094 filed Aug. 10, 2011, and entitled “Interactive Documentation System for Database Parameters.”

### TECHNICAL FIELD

The instant disclosure relates to databases. More specifically, the instant disclosure relates to database management systems.

### BACKGROUND

Database-driven applications, such as those for tracking air waybills, have high up-time requirements. Often, the application needs to be available twenty-four hours per day, seven days per week, and three-hundred-sixty-five days per year. Thus, performing maintenance on the application may create an inconvenience for users of the application. For example, if a parameter is changed, the application may become unstable. Thus, several versions of the application are often running in different environments. For example, one copy of the application may be operating in a production environment, in which active air waybills are managed. Another copy of the application may be operating in a test environment, in which users and administrators may modify parameters and perform testing to ensure updates to the application or parameters of the application do not reduce stability of the application. The test and production environments may be executed on different servers.

### SUMMARY

According to one embodiment, a method includes accessing a first database to retrieve documentation. The method also includes accessing a second database to retrieve values for at least one parameter referenced from a first database. The method further includes displaying the values and the documentation to the user.

According to another embodiment, a computer program product includes a non-transitory computer readable medium having code to access a first database to retrieve documentation. The medium also includes code to access a second database to retrieve values for at least one parameter referenced from a first database. The medium further includes code to display the values and the documentation to the user.

According to yet another embodiment, a system includes a parameter database. The system also includes a documentation database. The system further includes a processor coupled to the parameter database and coupled to the documentation database. The processor is configured to access a first database to retrieve documentation. The processor is further configured to access a second database to retrieve values for at least one parameter referenced from a first database. The processor is also configured to display the values and the documentation to the user.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a data management system for storing database parameters and documentation according to one embodiment.

FIG. 2 is a flow chart illustrating a method for displaying parameters and associated documentation according to one embodiment of the disclosure.

FIG. 3 is a block diagram illustrating an interface for displaying help according to one embodiment of the disclosure.

FIG. 4 is a block diagram illustrating an interface for displaying help for a parameter including a value for the parameter according to one embodiment of the disclosure.

FIG. 5 is a block diagram illustrating an interface for searching for parameters according to one embodiment of the disclosure.

FIG. 6 is a block diagram illustrating a display of parameters from a search including values and documentation according to one embodiment of the disclosure.

FIG. 7 is a block diagram illustrating a display of historical changes for a parameter according to one embodiment of the disclosure.

FIG. 8 is block diagram illustrating a data management system configured to store databases, tables, and/or records according to one embodiment of the disclosure.

FIG. 9 is a block diagram illustrating a data storage system according to one embodiment of the disclosure.

FIG. 10 is a block diagram illustrating a computer system according to one embodiment of the disclosure.

### DETAILED DESCRIPTION

A user interface may be provided to provide both documentation and database values for a parameter to eliminate the need for the user to switch between the documentation and the function that displays the database values for the parameters. For example, documentation regarding a parameter may be displayed along with the value for the parameter to assist the user or administrator during modification of the parameter value. The displayed information reduces the likelihood a user or administrator will enter an incorrect value for a parameter or mistakenly change a parameter.

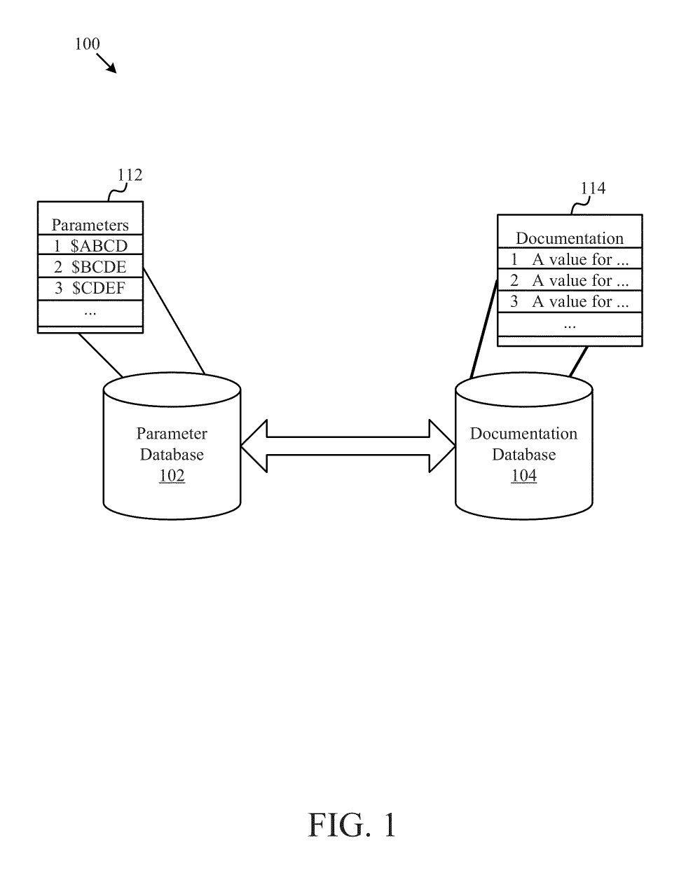

FIG. 1 is a block diagram illustrating a data management system for storing database parameters and documentation according to one embodiment. A parameter database 102 may include a table 112 storing parameters for an application operating in at least one environment. Each of the parameters may be associated with an identification value. According to one embodiment, the parameter database 102 may store parameters for multiple environments, such as a web server and a host environment. When the changes to parameters in the test environment have been vetted, the parameters from the test environment may be entered on the production environment upon request by the user.

According to another embodiment, the parameter database 102 may include additional tables (not shown) corresponding to additional environments such that parameter values for each environment are stored in separate tables. Additionally, the parameter database 102 may be stored across multiple servers. For example, the test environment and the production environment may have separate tables, and multiple servers store the parameter tables for each of the test environment and the production environment.

A documentation database 104 may include a table 114 storing documentation, such as the use of the parameters in processing business rules, for the parameters stored in the table 112 of the parameter database 102. Each entry in the table 114 may have an identification value corresponding to a parameter in the table 112. For example, the table 114 and the table 112 may be part of a relational database. The documentation database 104 may also include other tables for storing other information regarding parameters in the parameter database 104.

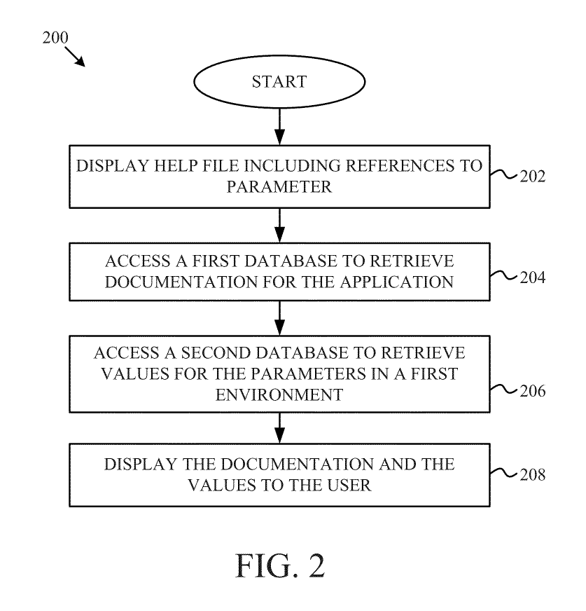

When an administrator or user attempts to access documentation for an application, data may be retrieved from both the documentation database 104 and the parameters database 102 for display by the user. FIG. 2 is a flow chart illustrating a method for displaying parameters and associated documentation according to one embodiment of the disclosure. A method 200 begins at block 202 with displaying a help file having documentation referencing parameters. The help file may be, for example, a hypertext markup language (HTML) document. The help file may be displayed at a request by the user while accessing a portion of an application or database. For example, a user may select a help button or press the ‘F1’ key when the user has a question about how a particular value is calculated. A user may then select a parameter displayed in the help file to access additional documentation regarding the parameter and view a value for the parameter in at least one environment. At block 204 a first database is accessed to retrieve documentation for the parameters. For example, documentation may be retrieved from the documentation database 104 of FIG. 1.

At block 206 a second database is accessed to retrieve values for the parameters. For example, values may be retrieved from the parameters database 102 of FIG. 1. According to one embodiment, the values are retrieved upon request by a user while viewing the documentation for the parameter. For example, a user may click on a parameter name hyperlink resulting in a pop-up box displaying the value and other details of the parameter retrieved from the second database.

At block 208 the parameter values and documentation are displayed to the user. The display may be generated and transmitted to the user or administrator, or a data file may be transmitted, such as an extensible markup language (XML) document containing the values and documentation for formatting and display by a client device. According to one embodiment, the display may include the values for parameters in the active environment, whether test or production.

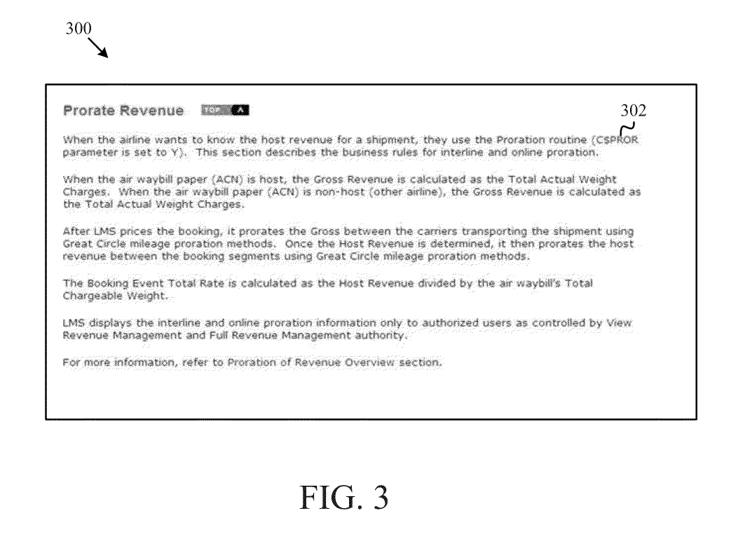

FIG. 3 is a block diagram illustrating an interface for displaying help according to one embodiment of the disclosure. A display 300 includes help documentation for “prorate revenue.” Documentation displayed in the display 300 may be retrieved from a hypertext markup language (HTML) file and/or from a documentation database, such as the documentation database 104 in FIG. 1. The display 300 may include a parameter 302. When the parameter 302 is clicked, values for the parameter 302 may be retrieved from a parameter database, such as the parameter database 102 of FIG. 1. According to other embodiment, values for the parameter 302 may be displayed in response to other triggers such as, for example, clicking on the parameter 302.

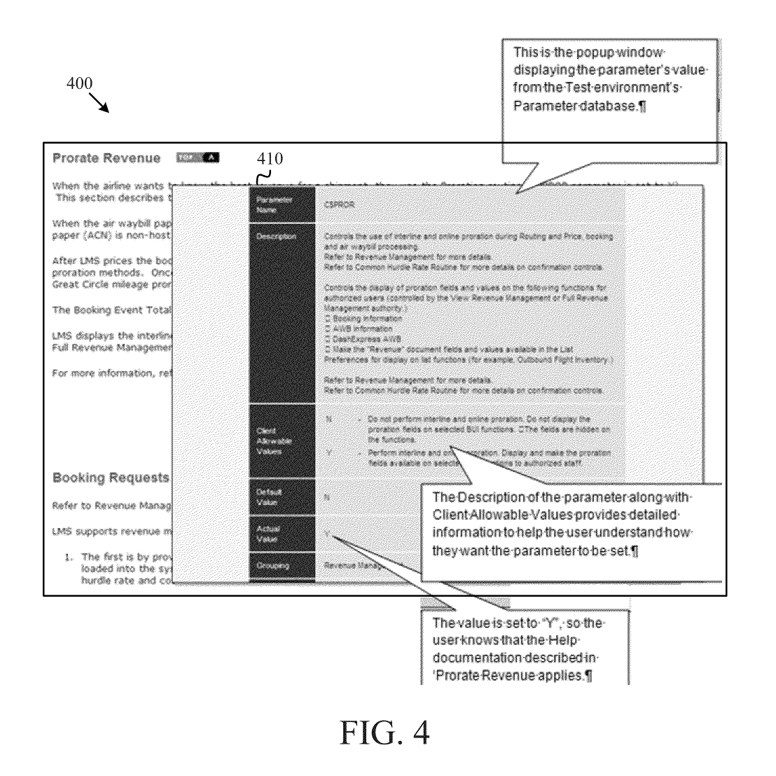

FIG. 4 is a block diagram illustrating an interface for displaying help for a parameter including a value for the parameter according to one embodiment of the disclosure. A display 400 includes the documentation display of display 300 of FIG. 3 and a pop-up window 410 displayed as a result of clicking on the parameter 302 of FIG. 3. The pop-up window 410 may include a value for the parameter retrieved from a parameter database, such as the parameter database 102 of FIG. 1. The pop-up window 410 may also include additional information for the parameter retrieved from a parameter database, such as the documentation database 102 in FIG. 1.

The documentation system described in FIG. 3 and FIG. 4 eliminates steps a user would otherwise perform to access documentation regarding parameters in the two databases. For example, previously a user would: (1) switch windows from a help window; (2) either display the parameter function from the window currently displaying the information function, which means if the user had entered data on the function, it would be lost when the user now displays the parameters function or the user could open a new window, sign on to the application, and then display the parameters function to display the parameter information from the parameters database; and (3) switch back to the help window to continue viewing the documentation.

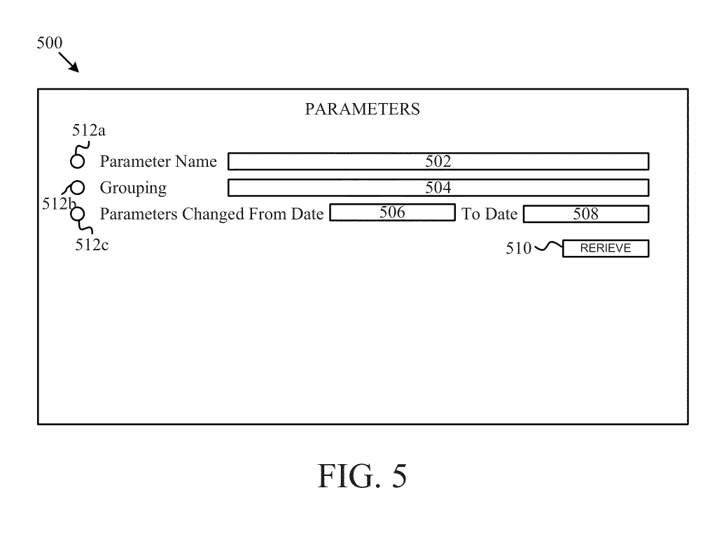

FIG. 5 is a block diagram illustrating an interface for searching for parameters according to one embodiment of the disclosure. An interface 500 provides a display for a user or an administrator to search for parameters. Options 512a-c allow a user or administrator to select search criteria. For example, if the option 512a is selected then parameters may be searched by parameter name. When the option 512a is selected the user or administrator may enter a parameter name for the search in text box 502. According to one embodiment, the user or administrator may include all or part of a parameter name in the text box 502 or enter a search string including, for example, wildcard characters. If the option 512b is selected then parameters may be searched by grouping. When the option 512b is selected then the user or administrator may enter a grouping in a text box 504. The text box 504 may also include a drop down selection to allow the user or administrator to select from a listing of possible grouping values. If the option 512c is selected then parameters may be searched by change date. When the option 512c is selected then the user or administrator may enter a beginning date in text box 506 and/or an end date in text box 508. According to one embodiment, a calendar may be displayed to the user or administrator to allow selection of a date for the text boxes 506 and 508. After a user or administrator selects search criteria from the interface 500, the user or administrator may select the retrieve button 510 to execute the parameter search.

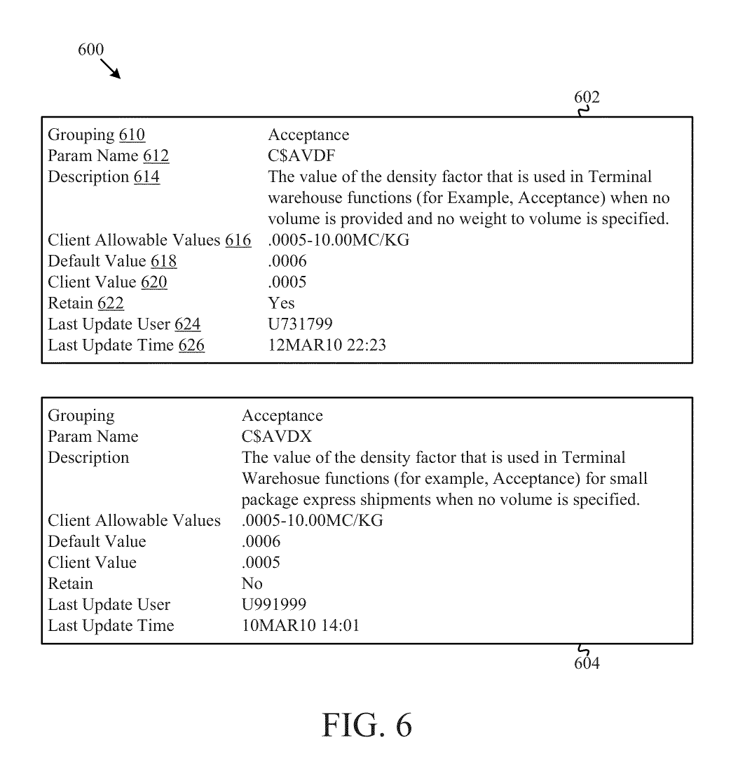

FIG. 6 is a block diagram illustrating data from the parameter database according to one embodiment of the disclosure. A display 600 displays one parameter's data from the parameters database. The record 602 may include a grouping 610, a parameter name 612, a description 614, a listing of client allowable values 616, a default value 618, a retain value 622, a last update user 624, and/or a last update time 626.

The grouping 610 may allow parameters to be grouped according to a common element. The parameter name 612 may display the parameter name. The description 614 may provide a description of the parameter. The client allowable values 616 may include the values allowed for the parameter, which may include a range or a discrete set of values. The default value 618 may display the documented default parameter value. The client value 620 may display the current parameter value. According to one embodiment, multiple client values may be shown in the client value 620 when the parameter is set for multiple environments. The retain field 622 may display yes if the parameter value shown will be retrained after the next synchronization of parameter values from one environment to another environment. The last update user 624 may display the last user who updated the parameter value. The last update time 626 may display the date and/or time the parameter was last updated. Additional fields (not shown) may include a host application field displaying the parameters host application and a validation rule displaying the rules used for the parameter's basic validation, such as a regular expression.

The data displayed in fields 610-626 of the record 602 may be retrieved from multiple databases, such as the parameter database 102 and the documentation database 104 of FIG. 1. According to one embodiment, the documentation may be retrieved from multiple tables in the documentation database 104. The value for each environment may be retrieved from separate tables in the parameter database 102.

The display 600 may include an option to edit any of the fields, such as the fields 620 or 622. For example, an edit button (not shown) may be displayed next to each of the fields 620 or 622 to allow a user or administrator to edit the value of each of the fields. According to one embodiment, certain users or administrators may have limited or no access to edit certain fields 620 or 622. For example, a user may have access only to change the client value 620 for some parameters (e.g., non-technical parameters), whereas an administrator may have access to change the client value 620 for all parameters (including technical and non-technical parameters).

According to one embodiment, the display 600 includes an option to download the records 602 and 604 in a data file. For example, the data of records 602 and 604 may be exported to a comma separated value (CSV) file or a spreadsheet (XLS) file.

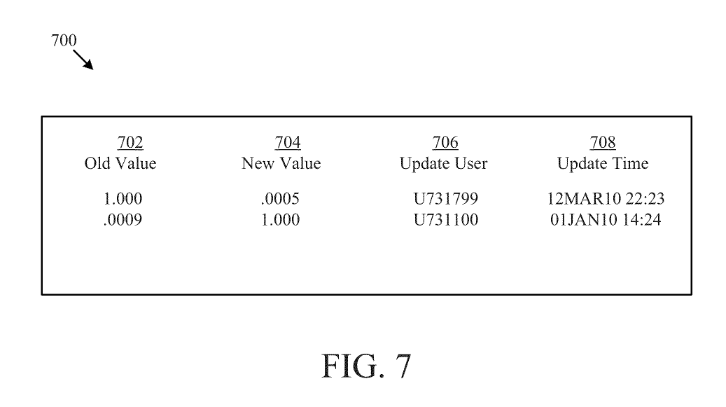

Each of the records 602 and 604 of the display 600 may include a value change history for the parameter displayed in the records 602 and 604. FIG. 7 is a block diagram illustrating a display of historical changes for a parameter according to one embodiment of the disclosure. A display 700 may include columns 702-708 for displaying a history of values for a parameter. The column 702 may display the old value for the parameter. The column 704 may display the new value for the parameter. The column 706 may include the username and/or user number of the user that requested the update. The column 708 may display the time and/or date the user in column 706 updated the parameter to the new value in the column 704 from the old value in the column 702. The display 700 may include multiple rows, in which each row corresponds to a changed value of the parameter.

An application system having a parameter display and modification system as described above eases administrative burdens and improves reliability of the applications executing on the application system. For example, displaying documentation along with parameters during editing of the parameters decreases the opportunity for a user or administrator to change the wrong parameter value.

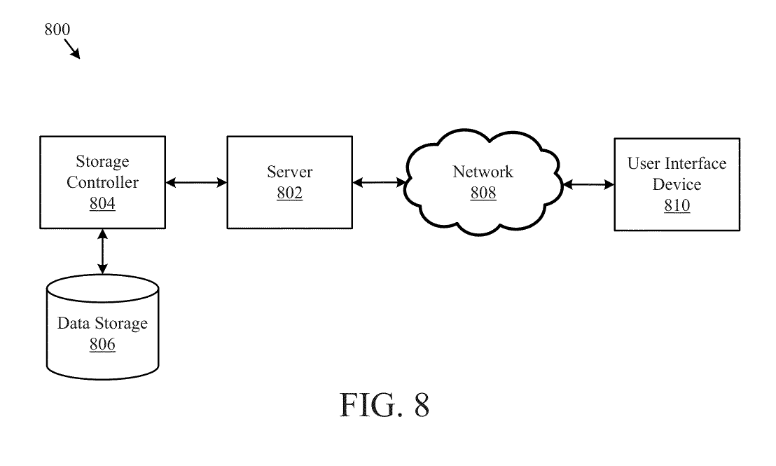

FIG. 8 illustrates one embodiment of a system 800 for an information system. The system 800 may include a server 802, a data storage device 806, a network 808, and a user interface device 810. The server 802 may be a dedicated server or one server in a cloud computing system. In a further embodiment, the system 800 may include a storage controller 804, or storage server configured to manage data communications between the data storage device 806 and the server 802 or other components in communication with the network 808. In an alternative embodiment, the storage controller 804 may be coupled to the network 808.

In one embodiment, the user interface device 810 is referred to broadly and is intended to encompass a suitable processor-based device such as a desktop computer, a laptop computer, a personal digital assistant (PDA) or tablet computer, a smartphone or other a mobile communication device having access to the network 808. In a further embodiment, the user interface device 810 may access the Internet or other wide area or local area network to access a web application or web service hosted by the server 802 and provide a user interface for enabling a user to enter or receive information.

The network 808 may facilitate communications of data between the server 802 and the user interface device 810. The network 808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 810 accesses the server 802 through an intermediate sever (not shown). For example, in a cloud application the user interface device 810 may access an application server. The application server fulfills requests from the user interface device 810 by accessing a database management system (DBMS). In this embodiment, the user interface device 810 may be a computer executing a Java application making requests to a JBOSS server executing on a Linux server, which fulfills the requests by accessing a relational database management system (RDMS) on a mainframe server.

In one embodiment, the server 802 is configured to store databases, pages, tables, and/or records. For example, the server 802 may store the parameters database 102 and the documentation database 104 of FIG. 1. Additionally, scripts on the server 802 may access data stored in the data storage device 806 via a storage area network (SAN) connection, a LAN, a data bus, or the like. The data storage device 806 may include a hard disk, including hard disks arranged in an redundant array of independent disks (RAID) array, a tape storage drive comprising a physical or virtual magnetic tape data storage device, an optical storage device, or the like. The data may be arranged in a database and accessible through structured query language (SQL) queries, or other data base query languages or operations.

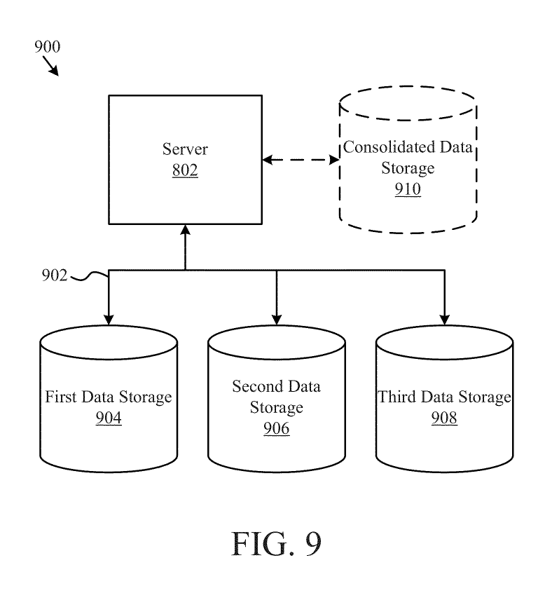

FIG. 9 illustrates one embodiment of a data management system 900 configured to store application parameters and documentation. In one embodiment, the data management system 900 may include the server 802. The server 802 may be coupled to a data-bus 902. In one embodiment, the data management system 900 may also include a first data storage device 904, a second data storage device 906, and/or a third data storage device 908. In further embodiments, the data management system 900 may include additional data storage devices (not shown). In such an embodiment, each data storage device 904, 906, and 908 may each host a separate database that may, in conjunction with the other databases, contain redundant data. Alternatively, a database may be spread across storage devices 904, 906, and 908 using database partitioning or some other mechanism. Alternatively, the storage devices 904, 906, and 908 may be arranged in a RAID configuration for storing a database or databases through may contain redundant data. Data may be stored in the storage devices 904, 906, 908, 910 in a database management system (DBMS), a relational database management system (RDMS), an Indexed Sequential Access Method (ISAM) database, a Multi Sequential Access Method (MSAM) database, a Conference on Data Systems Languages (CODASYL) database, or other database system.

In one embodiment, the server 802 may submit a query to select data from the storage devices 904 and 906. The server 802 may store consolidated data sets in a consolidated data storage device 910. In such an embodiment, the server 802 may refer back to the consolidated data storage device 910 to obtain a set of records. Alternatively, the server 802 may query each of the data storage devices 904, 906, and 908 independently or in a distributed query to obtain the set of data elements. In another alternative embodiment, multiple databases may be stored on a single consolidated data storage device 910.

In various embodiments, the server 802 may communicate with the data storage devices 904, 906, and 908 over the data-bus 902. The data-bus 902 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 802 may communicate indirectly with the data storage devices 904, 906, 908, and 910 by first communicating with a storage server (not shown) or the storage controller 804.

The server 802 may include modules for interfacing with the data storage devices 904, 906, 908, and 910, may include modules for interfacing with the network 808, and/or modules for interfacing with a user through the user interface device 810. In a further embodiment, the server 802 may host an engine, application plug-in, or application programming interface (API).

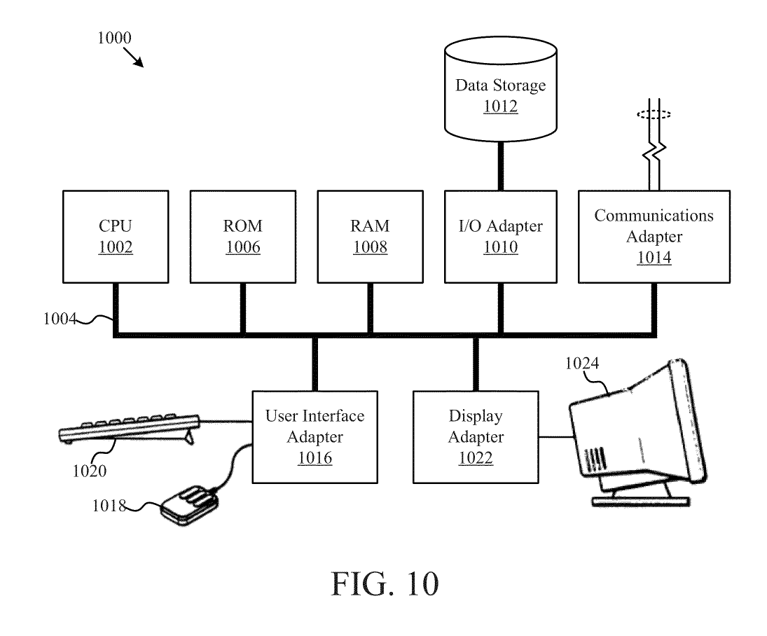

FIG. 10 illustrates a computer system 1000 adapted according to certain embodiments of the server 802 and/or the user interface device 810. The central processing unit (“CPU”) 1002 is coupled to the system bus 1004. The CPU 1002 may be a general purpose CPU or microprocessor, graphics processing unit (“GPU”), and/or microcontroller. The present embodiments are not restricted by the architecture of the CPU 1002 so long as the CPU 1002, whether directly or indirectly, supports the modules and operations as described herein. The CPU 1002 may execute the various logical instructions according to the present embodiments.

The computer system 1000 also may include random access memory (RAM) 1008, which may be synchronous RAM (SRAM), dynamic RAM (DRAM), and/or synchronous dynamic RAM (SDRAM). The computer system 1000 may utilize RAM 1008 to store the various data structures used by a software application such as databases, tables, and/or records. The computer system 1000 may also include read only memory (ROM) 1006 which may be PROM, EPROM, EEPROM, optical storage, or the like. The ROM may store configuration information for booting the computer system 1000. The RAM 1008 and the ROM 1006 hold user and system data.

The computer system 1000 may also include an input/output (I/O) adapter 1010, a communications adapter 1014, a user interface adapter 1016, and a display adapter 1022. The I/O adapter 1010 and/or the user interface adapter 1016 may, in certain embodiments, enable a user to interact with the computer system 1000. In a further embodiment, the display adapter 1022 may display a graphical user interface associated with a software or web-based application on a display device 1014, such as a monitor or touch screen.

The I/O adapter 1010 may couple one or more storage devices 1012, such as one or more of a hard drive, a flash drive, a compact disk (CD) drive, a floppy disk drive, and a tape drive, to the computer system 1000. The communications adapter 1014 may be adapted to couple the computer system 1000 to the network 1008, which may be one or more of a LAN, WAN, and/or the Internet. The communications adapter 1014 may be adapted to couple the computer system 1000 to a storage device 1012. The user interface adapter 1016 couples user input devices, such as a keyboard 1020, a pointing device 1018, and/or a touch screen (not shown) to the computer system 1000. The display adapter 1022 may be driven by the CPU 1002 to control the display on the display device 1024.

The applications of the present disclosure are not limited to the architecture of computer system 1000. Rather the computer system 1000 is provided as an example of one type of computing device that may be adapted to perform the functions of a server 802 and/or the user interface device 810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
accessing a first database to retrieve documentation;
accessing a second database to retrieve at least one value for the at least one parameter in a first database; and
displaying the documentation and at least one parameter value to the user.

2. The method of claim 1, further comprising displaying a help file before accessing the first database, the help file comprising information corresponding to the parameter.

3. The method of claim 2, in which the help file comprises documentation regarding the parameters.

4. The method of claim 2, further comprising receiving a request from a user for information about one parameter before the step of accessing the first database and the step of accessing the second database.

5. The method of claim 4, in which the step of receiving the request comprises receiving a notification that a user has clicked on the parameter.

6. The method of claim 2, in which the step of displaying the help file comprises transmitting a hypertext markup language (HTML) document and the step of displaying the values and the documentation comprises transmitting an extensible markup language (XML) document.

7. A computer program product, comprising:
a non-transitory computer readable medium comprising:
code to access a first database to retrieve documentation;
code to access a second database to retrieve at least one value for the parameter in a first database; and
code to display the documentation and the at least one parameter value to the user.

8. The computer program product of claim 7, in which the medium further comprises code to display a help file before accessing the first database, the help file comprising information corresponding to the parameter.

9. The computer program product of claim 8, in which the help file comprises documentation regarding the parameters.

10. The computer program product of claim 8, in which the medium further comprises code to receive a request from a user for information about one parameter before the step of accessing the first database and the step of accessing the second database.

11. The computer program product of claim 10, in which the code to receive the request comprises code to receive a notification that a user has clicked on the one parameter.

12. The computer program product of claim 8, in which the code to display the help file comprises code to transmit a hypertext markup language (HTML) document and the code to display the values and the documentation comprises code to transmit an extensible markup language (XML) document.

13. A system, comprising:
a parameter database;
a documentation database; and
a processor coupled to the parameter database and coupled to the documentation database, in which the processor is configured:
to access a first database to retrieve documentation;
to access a second database to retrieve at least one value for the at least one parameter in a first database; and
to display the documentation and the parameter values to the user.

14. The system of claim 13, in which the processor is further configured to display a help file before accessing the first database, the help file comprising information corresponding to the parameter.

15. The system of claim 14, in which the processor is further configured to receive a request from a user for information about one parameter before the step of accessing the first database and the step of accessing the second database.

16. The system of claim 13, in which the processor is further configured to receive a notification that a user has clicked on the one parameter.

17. The system of claim 13, in which the help file comprises a hypertext markup language (HTML) document and the display of the documentation and parameter comprises an extensible markup language (XML) document.
